(19) United States
(12) Patent Application Publication
(10) Pub. No.: US 2003/0155228 A1
(43) Pub. Date: Aug. 21, 2003

(54) Method and apparatus for air treatment

(76) Inventors: John Brian Mills, West Clandon, Surrey (GB); Adrian Richard Painter, Ashford, Kent (GB)

Correspondence Address: Y Rocky Tsao, Fish & Richardson, 225 Franklin Street, Boston, MA, 02110-2804, US

(21) Appl. No.: 10/148,684

(22) PCT Filed: Nov. 30, 2000
(86) PCT No.: PCT/GB00/04576

(30) Foreign Application Priority Data
Nov. 30, 1999 (GB) 9928335.0
Aug. 11, 2000 (GB) 0019842.4

(51) Int. Cl. B01J 19/12

(52) U.S. Cl. 204/157.3; 422/186.3; 204/158.2

(57) ABSTRACT

A ventilation system has a water treatment section (54) which applies droplets of water (58) to contaminated air. The water is then removed by an entrainment separator (62). The air is passed over a series of UV lamps (70) which generate ozone sufficiently fast to strip off the layer of ozone formed on the UV tubes. Photolysis, ozonolysis and oxidation all reduce the level of organic contaminants in the air stream. The air then passes over a second UV source which decomposes any remaining ozone.

This invention relates to a method of and apparatus for treating air particularly, although not exclusively, for removing odours, grease and other organic contaminants from air.

One of the persistent problems facing the designer of a ventilation system is the need to clean air that is removed from the area being ventilated in order, among other things, to reduce the amount of odours, grease etc. it contains. This is particularly true of a ventilation system for a kitchen or other area where food is cooked. Industrial and commercial processes such as food processing, food frying, meat cooking, vegetable oil extraction, meat and animal product rendering produce air streams which can contain entrained and vaporised grease and fat, burnt food products, smoke water vapour and volatile organic compounds (VOCs). Odours arise from these as well as directly from the food.

Known ventilation systems, such as those associated with large office blocks, often include a number of “air handling units” (AHU). The AHU comprises a series of filters of decreasing mesh size to remove particulate, and a fan which moves the air. AHUs are used to clean fresh air drawn into a building, to filter air that is recirculated and to clean dirty air before it is discharged from the building. Similarly an AHU is typically used at the discharge of kitchen air extract systems to remove grease, odours and particulates.

Furthermore when a ventilation system is used to remove grease and fats, e.g. from the aforementioned industrial and commercial processes, the ductwork downstream tends to become coated with grease and the like which represents a fire and hygiene hazard. Such ductwork therefore requires frequent cleaning.

In a commercial kitchen or industrial process, there is thus normally provision for removing grease by the use of grease filters in a canopy over the cooking area. A further method used to remove grease involves the use of an electrostatic precipitator, located downstream of the canopy. The aforementioned grease removal systems remove the bulk of the grease but not the odours. Also, filters need to be cleaned or replaced regularly and are themselves a potential fire and hygiene hazard.

A successful previous attempt to solve the problem of odours has been the provision of an air handling unit (AHU). The filters of the air handling unit serve to trap as many particles, including fat and grease, from the flow of removed air as possible. The problem of odours is tackled by adding a masking agent to the discharged air e.g. the vapour from a suitable masking oil.

As mentioned above, this arrangement has been shown to operate successfully in practical systems. However, its successful operation has been found to depend to some extent on the correct installation and routing of the associated ductwork. The provider of the air handling unit cannot however always control this installation, for example in circumstances where a kitchen is to be newly sited in an existing building, and so it is desired to provide a system which places a lesser reliance on such external factors.

One way of attempting to deal with odours is to increase the amount of masking agent used. However, this itself can cause a nuisance smell.

An alternative way to deal with odours is to use activated carbon filters to remove them. Whilst this works reasonably well, the filters need to be cleaned and replaced regularly which is both time-consuming and expensive.

Other techniques include incineration, chemical scrubbers or bio-filters. However none of these methods is completely satisfactory and none is able to effect a complete removal of unpleasant odours.

A further technique for decontaminating air is proposed in WO 97/39823. This technique involves directing a stream of secondary air or oxygen into a flow of contaminated air so as to enrich the oxygen content thereof and then irradiating the enriched flow with ultraviolet radiation in order to generate ozone. The ozone generated from the increased oxygen concentration oxidises organic contaminants in the airflow thereby converting them to carbon dioxide and water. The ultraviolet radiation also assists directly by photolysis.

It is an object of the present invention to reduce the amount of grease, odours and VOCs (referred to hereinafter as “organic contaminants”) in contaminated air and when viewed from a first aspect the invention provides an apparatus for reducing the level of organic contaminants in a stream of contaminated air comprising an ultraviolet light source and means for moving said air over the surface of the ultraviolet light, said apparatus being arranged so that the air is made to flow over said surface in such a way as substantially to strip away ozone formed on said surface.

When viewed from a second aspect the invention provides a method of reducing the level of organic contaminants in a stream of contaminated air comprising and means for moving said air over the surface of an ultraviolet light source, so that the air is made to flow over said surface in such a way as substantially to strip away ozone formed on said surface.

When viewed another aspect the invention provides an apparatus for oxidising organic contaminants in a stream of contaminated air comprising:

a cold combustion chamber;

at least one discharge lamp for generating ultraviolet radiation; and

driving means to move the air through said chamber and over the surface of the discharge lamp, wherein said driving means is arranged to cause the air to flow over said surface at a sufficient velocity substantially to strip away a layer of ozone formed thereon.

Similarly when viewed from a further aspect the present invention provides a method of oxidising organic contaminants in a stream of contaminated air comprising moving the contaminated air through a cold combustion chamber comprising at least one discharge lamp, said discharge lamp generating ultraviolet radiation thereby forming a layer of ozone on a surface thereof, wherein the air is moved so as to flow over the surface of the lamp at a sufficiently high velocity substantially to strip said ozone layer from said surface.

In accordance with the invention, ultraviolet radiation is emitted from a UV source—e.g. from a discharge lamp. This radiation causes photolysis reactions involving the degradation of complex molecules into simpler compounds. The ultraviolet radiation also converts molecular oxygen (O₂) present in the air into ozone (O₃), which attacks both the unreacted and the degraded organic compounds by the mechanism of ozonolysis to form ozonoids which further react to give oxidised species. The overall effect is to destroy the organic compounds, e.g. grease or odours, by a combination of ozonolysis, photolysis and oxidisation leading to mineralisation.

The inventors have however realised that although UV radiation generates ozone from molecular oxygen in the air, it also decomposes a proportion of the ozone generated. This results in an equilibrium residual level of ozone which forms in a layer on the surface of the discharge tube. It has now been appreciated that by driving air over the UV discharge lamp at a sufficiently high velocity, the ozone layer can be stripped away from the surface of the lamp. This means that ozone is removed from the source of radiation before it has an opportunity to decompose the ozone back to molecular oxygen. This greatly enhances the efficiency with which ozone is created and thus in accordance with the invention, the need to provide an auxiliary source of oxygen in order artificially to increase the concentration of oxygen in the air, is obviated.

Air flow over the UV discharge lamp is preferably arranged so that the Reynold's number R (R=DV/v, where D is the lamp diameter, V is the air velocity and v is the kinematic viscosity of the air) is within or preferably above the laminar-to-turbulent transition range and thus preferably into the turbulent region. The Reynold's number is preferably more than about 4,000, preferably more than about 5,000 and typical Reynold's numbers are in the range of 5,000 to 15,000.

This realisation by the Applicants that the efficiency with which an ultraviolet light source can break down organic substances in contaminated air is particularly enhanced if the air flow over the UV source is in the transition or turbulent region is novel and inventive in broad terms in its own right.

Thus when viewed from a yet further aspect the present invention provides an apparatus for treating air contaminated with an organic contaminant comprising at least one source of ultra-violet light over which said contaminated air is made to flow in use wherein the apparatus is arranged such that flow of said air is turbulent or in the transition to turbulence.

Similarly when viewed form another aspect the invention provides a method of treating air contaminated with an organic contaminant comprising making said air flow over at least one source of ultra-violet light such that flow of said air is turbulent or in the transition to turbulence.

Any suitable means may be used to achieve the desired turbulent or transitional flow. For example the surface of the UV source may be suitably configured or textured to generate turbulence or the transition to turbulence. Alternatively the bulk flow rate of air through the apparatus could be set so as to ensure the desired form of flow. This is not preferred however since the bulk flow rate is normally determined on the basis of other system considerations. Preferably means are provided to increase the local flow speed over the surface of the UV source so as to achieve the desired flow pattern or Reynold's numbers set out above. Such means could comprise another UV source—e.g. tube, the spacing between them being set so as to ensure the requisite flow speed for a given system flow rate. Alternatively one or more dedicated flow restricting means, such as rods or baffles could be provided to increase the flow speed over the surface of the UV source.

Such arrangements are believed to be novel and inventive in their own right and thus when viewed from a yet further aspect the present invention provides an apparatus for treating contaminated air by using ultraviolet light comprising at least one ultraviolet light source and means provided in conjunction with said light source for increasing the local flow speed over the light source by restricting the flow of air thereover.

Similarly when viewed from another aspect the invention provides a method of treating contaminated air by causing it to flow over at least one ultraviolet light source comprising increasing the local flow speed over the light source by restricting the flow of air thereover.

It will be appreciated by those skilled in the art that a complete air decontaminating apparatus may be provided in accordance with the invention which displays the aforementioned benefits of increased efficiency obviating the need to provide a separate oxygen source. However the inventors have further appreciated that the invention allows an air handling unit to be provided which can replace an existing air handling unit of the known type within a complete ventilation system. The benefits of being able to carry out such retrofitting are clear in that it is not necessary to replace an entire ventilation system to take advantage of the invention. This opens up the possibility of replacing an air handling unit in an already installed ventilation system. For example, if odour related problems are encountered in an existing system, the apparatus of the invention may be retrofitted. The odour related problems may be caused by poor positioning of the discharge terminal of the “cleaned” air, and re-positioning of the discharge terminal would normally involve major works. Instead, by retrofitting the apparatus of the invention, it is possible to avoid such works.

It will be seen that such an arrangement is advantageous in its own right and thus when viewed from a further broad aspect the present invention provides a modular air decontaminating unit for a ventilation system comprising at least one ultraviolet discharge lamp for generating ozone from oxygen in the air.

Modular air decontaminating units in accordance with this aspect of the invention have several advantages over known air handling units since they obviate the need for at least some of the physical filters previously provided thereby reducing both initial and maintenance costs and furthermore they can also avoid the need to add a masking agent to the discharged air.

It is possible in accordance with this aspect of the invention that the means for driving the air over the ultraviolet discharge lamp is provided elsewhere than the decontamination module, e.g. by an overall system fan or series of fans arranged to generate a sufficient flow rate through the system that the velocity of flow at the decontamination module is sufficient substantially to strip away a layer of ozone formed on the surface of the discharge lamp as set out in accordance with the first aspect of the invention. Preferably however the air decontamination module itself comprises such driving means such as a fan or the like, thereby allowing the module on its own to ensure sufficient decontamination of the air passing through it.

The ultraviolet discharge lamp specified in accordance with any of the aforementioned aspects of the invention may be arranged to emit at a spread of frequencies or predominantly at a single frequency. In a particularly preferred embodiment the discharge lamp is arranged to emit substantially UV-C radiation, preferably at a wavelength of approximately 185 nanometres (nm).

Although a single discharge lamp may be sufficient to provide adequate effect, preferably a plurality is provided. This also has the advantage that if one lamp should fail, the performance of the system will merely be impaired as opposed to it ceasing to function completely.

It will have been seen that in accordance with the invention as set out hereinabove, a UV light source is used to generate ozone which breaks down organic compounds through ozonolysis to reduce odours and grease etc. Even with careful design, embodiments of this invention may discharge small quantities of ozone with the exhausted air. Often this does not pose a significant problem since the discharge vent can be located high up on a building where any discharged ozone will quickly disperse and will not be breathed by humans and so does not represent a health hazard. Sometimes however the discharge vent needs to be located so as to discharge at a low level or into an inhabited area in which case small amounts of ozone could represent a health hazard and therefore should be removed.

Preferred embodiments of the invention thus comprise means for removing ozone from the discharged air stream. Even where such removal would not otherwise have been essential, it is desirable since it increases the system's design flexibility.

In one potential such embodiment, such means could take the form of a catalytic bed, e.g. comprising activated carbon, zeolites, metal oxides or precious metals. The bed serves both to break down ozone and to trap any remaining organic compounds and is therefore particularly useful in dealing with fluctuating contaminant loads. For example, when there is a high level of grease or the like entering the ventilation system, some organic compounds may survive exposure to the ultraviolet radiation and ozone but will then be trapped by the bed of e.g. activated carbon. When the entry level of contaminants is low, the e.g. activated carbon can break down any excess ozone produced by the ultraviolet radiation, thereby preventing discharge of ozone. In addition any trapped organic material can enhance the break down process by reacting with the ozone.

Such arrangements however are not without drawbacks. For example it has been found that in practical systems a large volume of catalyst, e.g. activated carbon is required. Not only does this have cost implications but it can make installation difficult where space is limited, as is often the case especially when installing in an existing building.

Ozone can also be decomposed by heating the air, but this is uneconomic since it requires a large amount of energy.

However as well as an appreciation that there is an equilibrium between production and decomposition of ozone in the presence of ultraviolet light, the inventors have further realised that in fact different parts of the emission spectrum are responsible for these processes. Thus in one particular embodiment a UV discharge tube has peaks in its emission spectrum at approximately 185 nm and 254 nm. The first of these, it has now been appreciated, converts molecular oxygen into ozone as has been discussed above, whereas the second wavelength decomposes ozone again to form molecular oxygen, but also produces highly reactive oxygen radicals. These radicals serve to further oxidise any remaining organic contaminants and thus the overall treatment process is enhanced.

Preferably therefore the means for reducing the level of unreacted ozone in the air discharged from the apparatus comprises a further ultraviolet light source operating predominantly at a wavelength for decomposing ozone.

This is novel and inventive in its own right and so when viewed from a further aspect the present invention provides an apparatus for treating air contaminated with organic contaminants comprising a first ultraviolet light source which in use emits light at at least a first wavelength for producing ozone and a second ultraviolet light source downstream of said first light source and which in use emits light at a second wavelength for decomposing ozone wherein said second light source either does not emit at said first wavelength or any such emission is substantially attenuated compared to the first light source.

Similarly when viewed from another the aspect the invention provides a method of treating air contaminated with organic contaminants comprising irradiating said air with a first ultraviolet light source emitting light at at least a first wavelength for producing ozone and irradiating said air with a second ultraviolet light source downstream of said first light source and emitting light at a second wavelength for decomposing ozone wherein said second light source either does not emit at said first wavelength or any such emission is substantially attenuated compared to the first light source.

Thus in accordance with these aspects of the invention an air treatment apparatus can be arranged to degrade organic contaminants by means of photolysis and ozonolysis as described hereinabove and thereafter a different wavelength of UV light can be used to decompose the ozone. Not only does this have the beneficial effect of reducing the amount of potentially harmful ozone emitted into the atmosphere, but it creates strongly oxidising radicals which oxidise any remaining organic contaminants, thereby further reducing the contamination level of the discharged air. These twin advantages, which go hand in hand, arise from the inventive deliberate deployment of different UV wavelengths.

The first and second wavelengths are each preferably in the UV-C band. The first wavelength is preferably approximately 185 nm. The second wavelength is preferably approximately 254 nm. In practical embodiments the first UV source emits at both the first and second wavelengths.

The two UV sources may be physically separate—e.g. two separate mercury discharge tubes with appropriate mercury pressures and quartz envelopes to provide the desired emission spectrum. Alternatively however the two sources may be integrated. For example a single mercury discharge tube could be provided with a quartz envelope wherein a different grade of quartz is used in different regions of the tube. These respective regions would then comprise the two UV sources.

It has further been appreciated that the benefits in terms of decreasing the level of organic contaminants by oxidation as a result of the liberation of radicals from the decomposition of ozone by UV can be realised regardless of the source of the ozone. Thus rather than using UV light to decompose ozone left over from UV-induced photolysis and ozonolysis, ozone could be deliberately introduced, e.g. from an external source, either additionally or exclusively so that it can be decomposed and the products thereof used to oxidise organic contaminants. Such a concept is novel and inventive in its own right and thus when viewed from a yet further aspect the present invention provides an apparatus for oxidising organic contaminants in a stream of air comprising means for introducing ozone into the airstream and an ultraviolet light source downstream thereof for irradiating said airstream with ultraviolet light at such a wavelength that it decomposes ozone in the airstream.

This aspect of the invention also provides a method of oxidising an organic contaminants in a stream of air comprising introducing ozone into the airstream and irradiating said airstream with ultraviolet light at such a wavelength that it decomposes ozone in the airstream.

The ozone may come from upstream in a larger system as the result of UV-induced ozone production as previously described, and indeed this is the case in the presently preferred embodiments. Alternatively the ozone may come from an external source. Such an external source could itself comprise a UV light source operating at a suitable wavelength to produce ozone—e.g. from ambient air or a source of oxygen. Alternatively another method such as corona discharge in dry air or oxygen could be used to generate the ozone.

As above, the ultraviolet light source is preferably one which emits in the UV-C band, most preferably at approximately 254 nm.

The UV source which serves to decompose ozone is preferably housed in a highly reflective chamber—e.g. one made of brightly polished metal such as stainless steel or preferably aluminium.

The oxidising reactions will not all take place instantaneously and the apparatus is therefore preferably arranged to give a suitable residence time for the oxidation reactions to be substantially completed. In fact since oxidation of the organic contaminants by the ozone can continue downstream of the ultraviolet light source can take place in accordance with the previous aspects of the invention, thereby enhancing the efficiency with which organic contaminants are removed, by applying the above concept more generally it will be seen that when viewed from another aspect the present invention provides an apparatus for treating contaminated air containing organic contaminants comprising an ultraviolet light source arranged to irradiate contaminated air streaming past it and a reaction chamber for containing said air for a minimum predetermined period, said period being sufficiently long to allow oxidation reactions involving the organic contaminants in the air to be substantially completed.

Similarly when viewed from another aspect the present invention provides a method of treating contaminated air containing organic contaminants comprising irradiating contaminated air streaming past an ultraviolet light source and containing said air for a minimum predetermined period in a reaction chamber, said period being sufficiently long to allow oxidation reactions involving the organic contaminants in the air to be substantially completed.

Thus it will be seen that in accordance with these aspects of the invention, not only can the efficiency with which organic contaminants are treated be increased, but the levels of unreacted ozone are reduced. It has been found that in certain preferred embodiments of the invention a residence time of between 0.25 and 4 seconds enables most of the reactions to be completed, and a residence time approximately within this range is therefore preferred.

The reaction chamber could be a special vessel suitably sized for the purpose, but preferably it simply comprises a duct for conveying irradiated air from the UV light source, which is sufficiently long to give the desired residence time. Clearly the actual length required will depend upon the flow speed of the airstream.

In accordance with all of the aspects set out hereinabove, air contaminated with organic contaminants is irradiated by at least one ultraviolet light source to remove the contaminants e.g. by breaking them down or oxidising them. Suitably arranged embodiments of these aspects of the invention can treat contaminated air directly from e.g. a cooking appliance or the like. Preferably however the contaminated air is brought into contact with water droplets prior to being irradiated by the UV light.

The water has the effect of condensing vaporised organic material, knocking out particulate matter and cooling the air. Furthermore this water treatment raises the humidity of the air. This is beneficial when the air is to be irradiated downstream with UV light since it has been found that particularly the wavelength which decomposes ozone, also causes hydroxyl radicals to form. These are strong oxidising agents and so they enhance the efficiency with which organic contaminants in the airstream are removed. Removing particulate matter and large droplets of grease, as such water treatment will help to do, before UV irradiation is beneficial in itself since it has been found that large droplets and particles can hamper the decontamination processes which are driven by UV irradiation since they are more difficult to break down.

Thus when viewed from a further broad aspect the present invention provides an apparatus for removing organic contaminants from a stream of air passing therethrough comprising means for applying droplets of liquid to said air stream and an ultraviolet light source downstream of said liquid application means for irradiating said airstream.

Correspondingly the invention provides a method of removing organic contaminants from a stream of air comprising applying droplets of liquid to said air stream and irradiating said airstream with ultraviolet light downstream of said liquid application.

Although any liquid having suitable properties could be used, preferably the liquid comprises water, most preferably as at least a majority constituent.

Preferably the means to apply droplets of liquid is arranged to distribute the liquid in the form of a spray or curtain, by passing the liquid over a suitable structure in the air stream to create the required droplets.

The liquid used to treat the contaminated air can be used just once and then discarded. Preferably however it is recycled at least once, most preferably continuously. This enables the apparatus to be self-contained and minimises the amount of liquid used. A single circuit may be used, but in some preferred embodiments more than one circuit is used. Most preferably these are arranged such that the coldest liquid is used to contact the air exiting the liquid treatment apparatus. For example liquid which is heated by contact with the hot air could be cooled in some form of heat exchanger before being brought into contact again with the airstream before it exits the apparatus.

The treatment liquid. e.g. water, will during use collect grease and solids. When it has been removed from the air it is preferably passed through a settling container and a grease removal means is preferably provided to remove grease floating on the water. The grease removal means could comprise a suitably arranged outlet which skims off floating grease. Preferably the grease removal means comprises a weir under which the water is made to flow, thereby trapping the floating grease on the weir.

Additionally or alternatively means may be provided to remove solids from the water. If no such means are provided, the solids may simply be allowed to settle out and the settlement container periodically cleaned.

In some preferred embodiments, e.g. where enhanced cooling of the contaminated air is required, the liquid may be cooled prior to applying it to the air stream—e.g. in an external cooler.

It has been realised that whilst it is desirable for the air being irradiated by UV light to be humid, water etc. on the internal surfaces should be avoided as far as possible since this can hinder efficient operation of UV tubes and can lead to corrosion in metal ductwork. Once the contaminated air has been brought into contact with the liquid droplets, the air will almost inevitably contain entrained liquid droplets. Preferably therefore separation means are provided to separate the liquid droplets from the air. Suitable means may for example comprise a baffle filter, mesh filter or the like.

Even if, as is preferred, entrained water droplets are removed from the airstream, the air will be likely still to contain water vapour. This is particularly so in the preferred application of the invention where the incoming contaminated air is at an elevated temperature. Indeed in such applications the air will be close to being saturated with water vapour which will condense out as the air cools. In preferred embodiments means are provided to reduce the humidity of the airstream. This may comprise means to heat the air further, but preferably comprises means to add a gas, e.g. air, having a lower dew point than the main air stream. By reducing the humidity of the air exiting the liquid contacting zone, the tendency for condensation to form, e.g. further downstream in an air handling system, is reduced. This is beneficial for the reasons given above.

It will be appreciated therefore that the reduction of humidity is novel and advantageous in its own right and thus when viewed from a further aspect the present invention provides an apparatus for treating contaminated air comprising means for controlling the humidity of air passing through the apparatus to be within a predetermined range.

Similarly when viewed from another aspect the present invention provides a method of treating contaminated air comprising controlling the humidity of air passing through an air treatment apparatus to be within a predetermined range.

By ensuring that the air has a humidity within a certain range, preferably which is as high as possible but below its dew point (typically with the air temperature being between 2 and 5° C. higher than the dewpoint) the efficiency with which the organic compounds are broken down and oxidised is improved as compared to the same process applied to contaminated air with a significantly lower humidity value for the reasons given earlier—namely that additional oxidising radicals are produced from water vapour. To give an example of the improvement in performance achievable in accordance with this aspect of the present invention, an experiment was carried out by passing dry air containing formaldehyde vapour as a test organic contaminant at ambient temperature through an apparatus for irradiating it with UV light. The degradation in the amount of formaldehyde resulting from the UV irradiation was found to be 54%. The experiment was then repeated, but this time the air was passed through water at 30° C. and 50° C. respectively prior to entering the UV apparatus. The air was therefore correspondingly more humid in each of these two cases. It was found that the degradation of formaldehyde achieved was 72% and 94% respectively in the latter two cases, i.e. an extremely significant improvement.

Such an arrangement is therefore both novel and inventive in its own right and when viewed from a further aspect the present invention provides an apparatus for treating contaminated air comprising an ultra-violet light source arranged to irradiate contaminated air passing through the apparatus, and means for regulating the humidity of the air passing through the apparatus prior to it being irradiated by the ultra-violet light source.

From a further aspect the invention provides a method of treating contaminated air comprising irradiating contaminated air with ultra-violet light and regulating the humidity of the air passing through the apparatus prior to it being irradiated by the ultra-violet light.

The means for regulating the humidity of the air is preferably arranged to lower the humidity. This may be achieved by heating the air, but preferably or at least additionally, the humidity regulating means is arranged to introduce a gas or mixture of gases, e.g. air, having a lower humidity than the incoming contaminated air, thereby reducing the overall average humidity of the air which is irradiated. Of course if humidity were to be increased this could be achieved correspondingly by cooling the air or adding wetter air or both.

It will be appreciated that the apparatus and methods described herein are not restricted to their use in treating the discharge from kitchens. They may also be used in other applications where air handling units are normally used, for example, to clean fresh air drawn into a building or to clean air that is to be recirculated in a building.

Some preferred embodiments of the present invention will now be described, by way of example only, with reference the accompanying drawings in which:

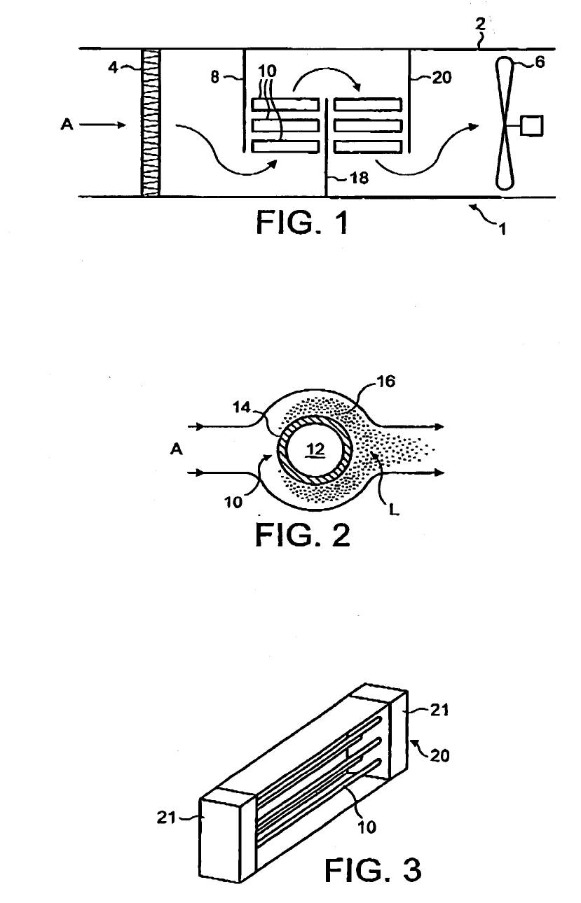

FIG. 1 is a schematic cross-sectional view of an air handling unit embodying the present invention;

FIG. 2 is an enlarged cross-section of an ultraviolet lamp;

FIG. 3 is a schematic perspective view of a cassette of ultraviolet discharge lamps;

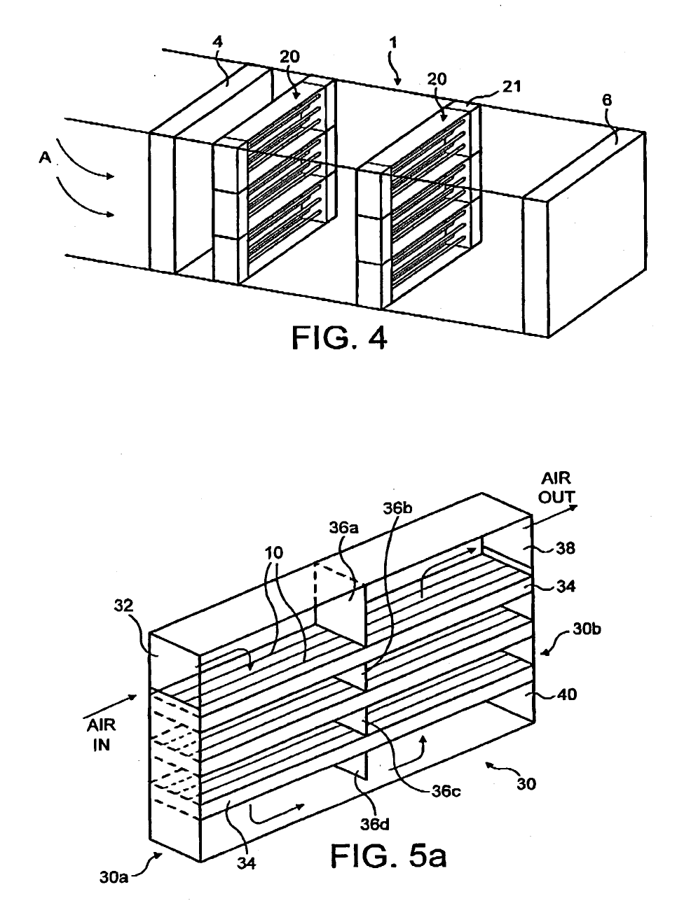

FIG. 4 is a schematic perspective view of a second embodiment of air handling unit, employing cassettes as shown in FIG. 3;

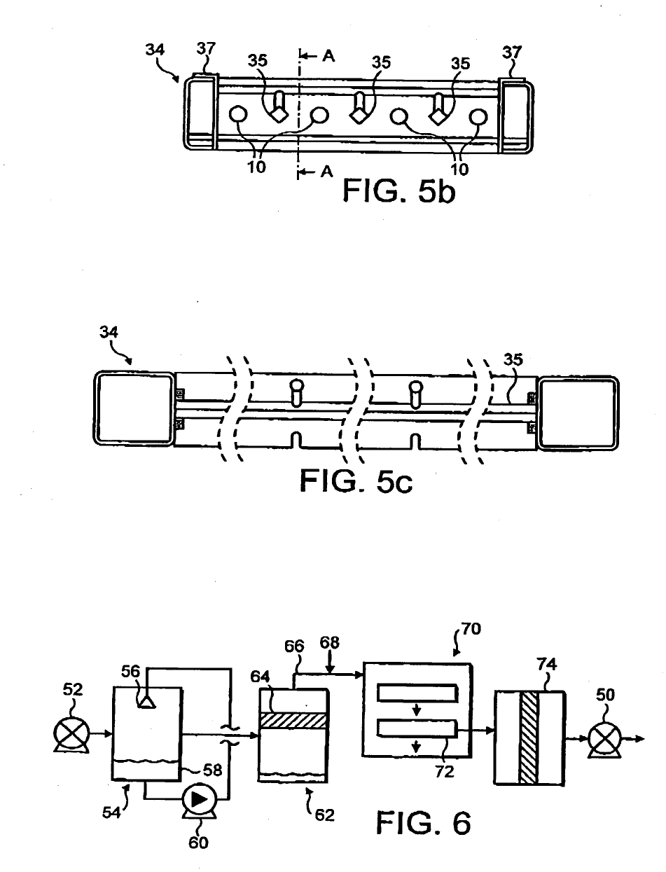

FIG. 5a is a partly schematic perspective view of a UV treatment unit in accordance with another embodiment;

FIG. 5b is a cross-section through one of the cassettes of UV tubes shown in FIG. 5a showing the intermediate rods;

FIG. 5c is a cross-section on the line A-A of FIG. 5b;

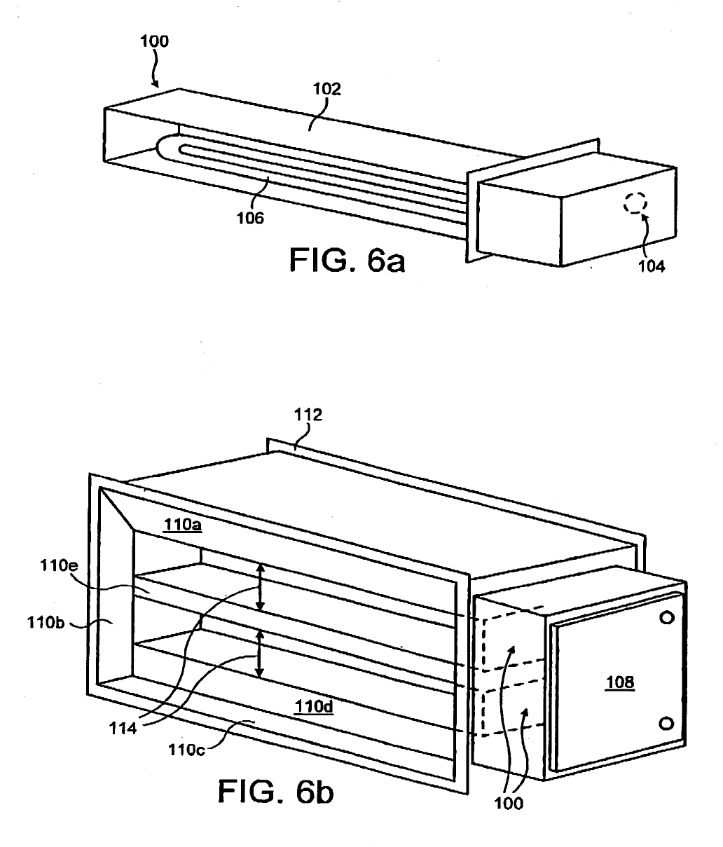

FIG. 6 is a schematic view of an air treatment system embodying various aspects of the invention;

FIG. 6a is a close-up view of an insert unit from the second UV reactor shown in FIG. 6;

FIG. 6b is a perspective view of the second UV reactor with the UV tubes omitted;

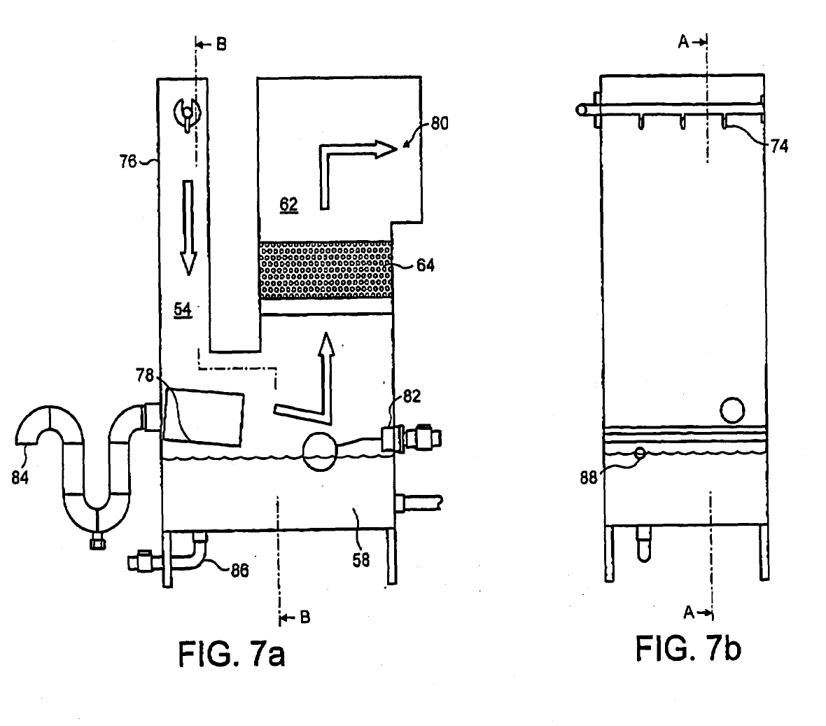

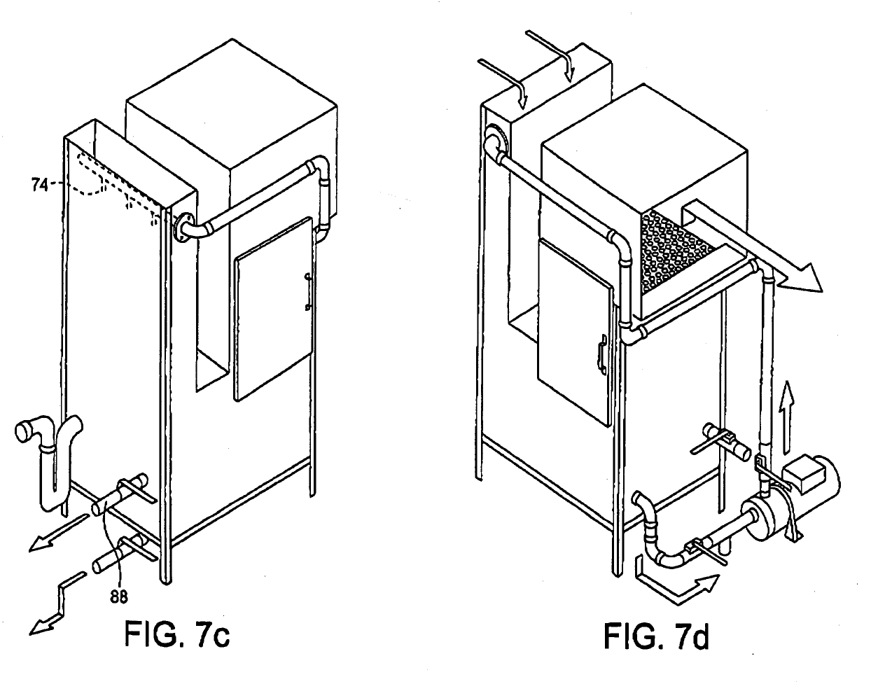

FIGS. 7a to 7d are respectively two cross-sectional and two perspective views of a combined water treatment and entrainment separator unit as depicted schematically in FIG. 6;

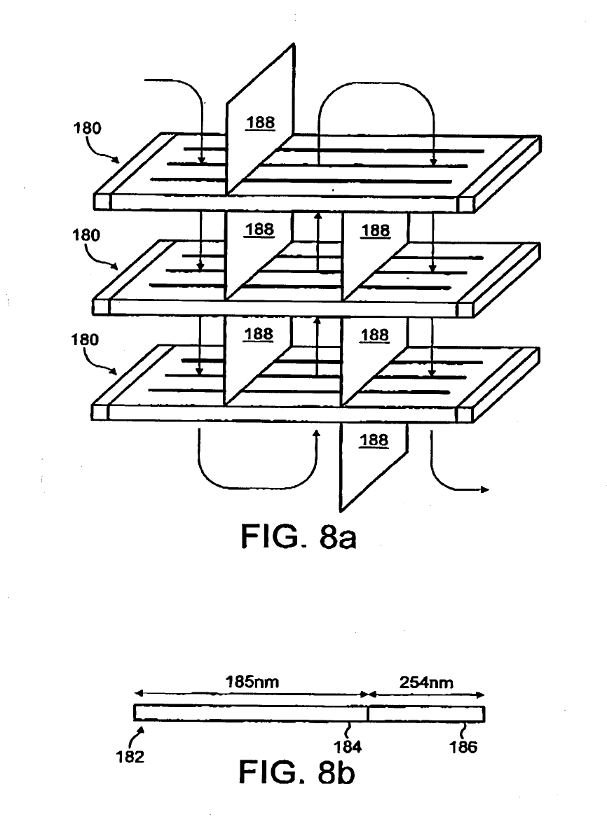

FIG. 8a is a schematic view of an alternative arrangement of two UV sources; and

FIG. 8b is a schematic view of one of the UV tubes used in FIG. 8a.

FIG. 1 shows an air handling unit 1 which is part of a kitchen ventilation system for removing contaminated air from a kitchen, treating it, and discharging it to the atmosphere. The air handling unit has the general form of an elongate channel 2 into which contaminated air enters from the left end (as viewed from FIG. 1) and passes out of the right end for discharge into the atmosphere.

As the stream of air A, which is contaminated with complex organic substances such as grease and fat from an industrial kitchen, enters the channel 2 it impinges upon a filter 4. This filter in not essential but can provide some degree of protection from excessive quantities of solid particles in the air flow. It is thus intended to trap larger solid particles rather than to remove grease etc.

The air is caused to flow by means of a fan 6 provided at the far end of the air handling unit. This fan extracts air from the unit, thereby causing air to flow in at A.

The air which has passed through the filter 4 then passes onto and around a baffle 8. This and a second baffle 18 guide the air to flow across a series of ultraviolet discharge lamps 10 which emit radiation in the UV-C band. More particularly the lamps 10 are low pressure mercury vapour lamps such as Slimline Germicidal Lamps G36T6VM from Atlantic Ultraviolet or G67T5VH Instant Start Lamps from Light Sources, Inc.

As is seen more clearly in FIG. 2, the discharge lamps comprise a mercury vapour encapsulated in an elongate quartz tube 14. When a voltage is applied across the ends of the tube, radiation in the UV-C range is emitted from the quartz tube 14 and interacts with O₂ molecules in the air to generate ozone which forms as a layer 16 on the surface of the tube 14. As the air A flows over the surface of the tube, it forms a low pressure zone L downstream of the tube. This sucks in the layer of ozone 16 thereby stripping it away from the surface of the tube 14. The ozone is then carried away by the airflow and is turbulently mixed with it. The ozone breaks down grease and other complex organic material in the air through ozonolysis.

Returning to FIG. 1, once the air has flowed over the first series of UV lamps 10, the second baffles 18 and a third baffle 20 direct it over the second series of UV lamps 10. Ozone generated by the second series of UV lamps 10 may continue to react with any remaining organic compounds downstream of the lamps 10. Thereafter the thus decontaminated air is driven out of the unit by the fan 6 and may be vented to the atmosphere without causing a nuisance. The venting may be direct from the air handling unit, with no further treatment, or via a catalytic, e.g. activated carbon, bed as described earlier.

As will be seen the air handling unit 1 described above is self-contained and may be inserted into a preinstalled ventilation system without the need for substantial modification to the rest of the system. Indeed since the interior components of the unit resemble those in commercially available air handling units, the latter may simply be modified e.g. by removing some of the filters therefrom and replacing them with the series of baffles 8, 18, 20 and UV tubes 10 depicted in FIG. 1. It is then only necessary to ensure that the fan controller is properly programmed to ensure a sufficient air velocity over the tubes.

FIGS. 3 and 4 show a second embodiment. FIG. 3 shows a cassette 20 with a stainless steel end housing 21 at each end. Four ultraviolet discharge lamps 10 extend in parallel manner between the end housings. An air handling unit 1 (see FIG. 4) has a filter 4 at its upstream end and a fan 6 at its downstream end. Two stacks of cassettes 20 are provided in the air flow path, each stack consisting of three cassettes. There are therefore six cassettes altogether, each with four lamps 10, giving a total of twenty four lamps. No baffles are provided in this embodiment.

FIG. 5a shows, semi-schematically, the UV lamp module of a third embodiment of the invention. The module comprises a casing 30 in the form of a rectangular stainless steel box which is elongate in the direction in the main direction of airflow. The upstream end of the box 30a has a rectangular opening 32 at the upper end to admit the air stream into the module. Inside the module 30 are three elongate cassettes 34 of UV tubes 10. Each cassette comprises a row of four tubes 10 as well as the associated power supplies etc. As before, these are low pressure mercury discharge tubes enveloped by quartz. The tubes used in the described embodiment emit at 185 nm and other, longer wavelengths particularly 254 nm.

Interspersed between the tubes 10 are three thinner metal tubes 35. These are omitted from FIG. 5a for clarity but may be seen in the cross-sections of FIGS. 5b and 5c. These tubes 35 are diamond-shaped in cross section and serve to restrict the width of the gap between the UV tubes 10 and therefore increase the local flow speed over the surface of the tubes. The Reynold's number of the air flowing over the tube is approximately 5,000 when this embodiment is operated at a standard air flow rate. Blanking plate 37 are provided at respective lateral sides of the cassette in order to prevent air leaking around the edges of the cassette.

Returning to FIG. 5a, it may be seen that halfway down the module 30 is a series of co-planar baffles 36a-36d. These are normal to the general direction of the horizontally flowing stream of air and so serve to deflect it downward through the rack of UV cassettes 34. The lowermost baffle 36d stops short of the bottom of the module casing so as to provide a path for the airflow underneath it. On the other side of the baffles, the air is made to change direction again and pass upwardly through the bank of UV cassettes 34 by the far end wall 30b of the casing. The air then exits through a rectangular outlet 38 formed in the upper part of the far end wall. A door 40 is also provided in the far end wall 30b in order to provide access to the interior of the module—e.g. to replace the UV cassettes 34.

FIG. 6 is a schematic diagram of an air treatment system representing another embodiment of the present invention. A fan 50 is provided at the end of the system in order to create a reduced pressure and therefore pull air through the system. Initially air emanating from a cooking appliance indicated schematically at 52 is drawn into the system and into a water treatment unit 54. The water treatment unit is in the form of a chamber having a spray nozzle 56 at the upper part thereof arranged to spray water at the incoming air. A water reservoir 58 forms in the lower part of the chamber and a pump 60 circulates the water from the reservoir 58 back to the spray head 56. Also provided, although not shown in FIG. 6, is a drain pipe at the water surface level which skims the surface of the reservoir 58 to remove any solids or liquids such as grease floating on top of the water.

Downstream of the water treatment unit 54 is an entrainment separator 62 for removing droplets of water entrained in the airflow exiting the water treatment unit 54. This entrainment separator comprises a knitted wire mesh 64 placed across the air flow path which captures any such droplets which then drip onto the base of the separator 62.

A duct 66 conveys the air from the top of the entrainment separator 62 to a UV irradiation unit 70. However before the air reaches the UV unit 70 an additional stream of air 68 is injected into the main flow. This air is simply ambient air which has been heated by a heater (not shown).

The UV unit 70 is shown schematically as having just two UV cassettes 72 with the air passing over them only once. In practice however the UV unit 72 is as shown in FIG. 5, although many other configurations are possible. Air exiting the UV unit 70 is conveyed to a second UV unit 74. This is shown in greater detail in FIGS. 6a and 6b. Unlike the first UV unit 70 shown in FIG. 5, the second unit 74 comprises just two U-shaped UV discharge lamps which are framed within respective UV lamp insert units 100. One such unit is shown in FIG. 6a. The insert unit 100 comprises an rectangular open box-like frame 102. One of the two smallest faces is provided with an electrical connection box 104 which makes electrical connection to the UV tube 106 and also contains a standard starter module.

The UV tube 106 is a UVI 260 U available from uv-technik Speziallampen GmbH, Germany operates essentially only at 254 nm and longer wavelengths—i.e. it does not emit at 185 nm as those in the first unit 70 do. Moreover the tube 106 is U-shaped as opposed to being simply straight as the previously described UV tubes have been and thus electrical connection may be made to both ends thereof on the same side of the insert unit 100. The tube 106 extends across the width of the frame 102 so that air passing through the unit 100 is irradiated by the tube 106.

As will be seen from FIG. 6b, two insert units 100 are stacked one above the other in the second UV unit 74. It should be noted however that the actual UV lamps have been omitted from FIG. 6b for purposes of clarity. A single box 108 houses the two electrical connection boxes of the insert units 100. The vertical spaces above, below and between the insert units are covered by panels 110a-e to ensure that air can only pass through the unit 74 via the channels 114 formed by the frames of the two insert units 100. Mounting flanges 112 are provided for installing the unit.

No baffles or flow restricting rods are provided in this chamber since the absorption range of the 254 nm radiation is significantly greater than the 185 nm radiation, and since there is no competition between ozone production and destruction, there is no need for turbulent flow over the UV lamps.

Air leaving the second UV unit 74 is drawn through the fan 50 and discharged into the atmosphere.

FIGS. 7a to 7d are respectively two perspective views and two cross-sections through a combined water treatment unit 54 and entrainment separator 62 which can be used in the system depicted in FIG. 6. FIG. 7a is a cross-section on the line AA in FIG. 7b and FIG. 7b is a cross-section on the line BB in FIG. 7a. The unit is substantially U-shaped with the water treatment 54 and entrainment separator 62 being provided in respective limbs thereof. As may be seen especially from FIGS. 7b and 7c, the spray nozzle 56 is in the form of three collinear square nozzles 74. The nozzles 74 are provided at the top of a narrow vertically extending channel 76 forming one limb of the U shape and which is open at the top to allow the hot, contaminated air into the unit. Water is therefore sprayed onto the airstream along its direction of flow.

At the lower end of the vertical channel 76 is a deflector 78 which serves to help deflect the downwardly flowing air stream across the unit and back up through the wire mesh filter 64. Thereafter the air flows through an opening 80 in the side wall of the rightmost limb.

A ball valve arrangement 82 is used to maintain the level of the reservoir 58 and an overflow pipe 84 is also provided in case this fails. A drain pipe 86 is provided for periodically draining water from the reservoir 58. As may be seen from FIGS. 7b and 7c an further outlet pipe 88 is provided at the water level in the reservoir to skim condensed grease and fats from the surface of the water by surface tension forces. In an alternative arrangement (not shown) the water is made to respectively to underflow and overflow a pair of weirs in order to remove the floating grease.

Operation of the system shown in FIGS. 6 and 7 will now be described. Air emanating from the cooking appliance 52 will be contaminated with grease, odours and other organic contaminants. This air is drawn into the system by means of the fan 50 at the downstream end. The air enters the water treatment unit 54 at the top of the narrow vertical channel 76 and flows past the water spray nozzles 74 which spray water into the air along its direction of flow. This has the effect of condensing some of the vaporised organic material in the air stream, and knocking out any particulate matter. It also has the effect of cooling the air stream. The water in the reservoir 58 will collect grease and solids which have been removed from the air. The solids will sink to the base of the reservoir 58 and are removed when the reservoir is periodically drained through the lower drain pipe 86. The grease will float on the surface and is removed by surface tension force pulling it into the skimming pipe 88.

Air leaving the water spray region 54 will contain entrained droplets of water. Some of these are deposited as the air is made to change direction by the deflector 78 and then flow upwardly through the wire mesh layer 64. The mesh layer 64 traps any remaining water droplets so that the air exiting through the aperture 80 and thus into duct 66 is essentially free of entrained water droplets. However the air leaving this unit will be close to saturation with water vapour. Warm air 68 is thus injected to lower the relative humidity of the airstream to prevent condensation and formation of water droplets. The resultant air stream will therefore be humid but below its dew point.

The air then enters the first UV unit 70 and is made to flow in both directions over each cassette 72 of UV tubes. The tubes emit predominantly at 185 nm and 254 nm. The former wavelength creates ozone from molecular oxygen in the airstream. As a result of the semi-turbulent airflow over the surface of the tubes, much of this is stripped away before it is decomposed again by the 254 nm light. As described earlier, the combination of UV light, moisture and ozone degrade organic contaminants within the airstream by means of photolysis, ozonolysis and oxidation. The oxidation reactions can be complete to give carbon dioxide and water as the principal end products, or incomplete to give molecules of lower molecular weight than the original organic compounds plus partially oxidised compounds in addition to the water and carbon dioxide.

As well as the above, air leaving the first UV unit 70 will contain trace amounts of ozone. However the 254 nm UV tube in the second UV unit 74 decomposes this ozone to form molecular oxygen and oxygen radicals. The 254 nm UV light also liberates hydroxyl radicals from the water vapour in the air. As well as decomposing the remaining ozone, the radicals created form a strongly oxidising environment, both in the chamber 74 itself and as they are carried down the subsequent ducting, which further degrades any remaining organic contaminants. When airflow through the system is within its intended operating rate, air will remain inside the chamber 74 and downstream ducting between approximately 0.25 and 4 seconds.

The air finally passes through the fan 50 before emerging into the environment, substantially odourless and uncontaminated by organic contaminants or ozone.

FIGS. 8a and 8b. show schematically an alternative arrangement for irradiating air with two different UV sources. In this arrangement three cassettes 180 of four UV tubes 182 are provided as before. However in contrast to the embodiments described above, as may be seen from FIG. 8b, each tube 182 is divided into two longitudinal regions 184 and 186 in the ratio 2:1. The respective regions 184, 186 are defined by two different grades of quartz used for the envelope of the tube.

The leftmost and largest region 184 is provided with a high grade quartz which transmits the peak in the discharge spectrum of the mercury on the tube at 185 nm. The rightmost region 186 of the tube however is provided with a lower grade quartz which does not transmit this wavelength, but instead transmits essentially only the peak at 254 nm (and other, minor longer wavelength peaks).

As is shown in FIG. 8a, a series of perpendicular baffles 188 force air flowing into the apparatus to pass through it in a serpentine manner so as to flow over each cassette 180 a total of three times. By arranging the baffles 188 on the right to coincide with the boundary between the two regions 184, 186 of the tubes, the air is thus made to flow twice over each region 184 of emission predominantly at 185 nm and once over each region of 254 nm emission. This has the same effect as the embodiment described with reference to FIG. 6—namely that ozone is generated by the 185 nm UV to degrade organic contaminants and any excess ozone remaining is subsequently destroyed by the 254 nm UV.

### EXAMPLE

Some examples of the application of the present invention will now be given. An air handling unit of the same type as that shown in FIG. 4 was constructed with a square cross-section 1.2 m by 1.2 m. The twenty-four UV discharge lamps were powered by a 220 V supply so as to generate UV radiation with a wavelength predominantly at 185 nm. During steady state operation an airflow of 3 cubic metres per minute was measured.

Test air containing grease contaminants was admitted into the unit and was found upon exit form the downstream end to have no perceptible odour.

Two further tests were carried out with respectively formaldehyde and styrene being used as test organic contaminants. It was found in the first test that an initial concentration of 229 milligrams per cubic metre of formaldehyde was reduced to 14 milligrams per cubic metre—i.e. a 94% reduction. In the second test the styrene concentration was reduced from 139 milligrams per cubic metre to 15 milligrams per cubic metre—i.e. an 89% reduction. In the case of the formaldehyde, the concentration was measured using the reaction of aqueous formaldehyde with phenyl hydrazine and potassium ferricyanide as described in Colorimetric Analysis (Allport) 1947 pp 397-398.

1. An apparatus for reducing the level of organic contaminants in a stream of contaminated air comprising an ultraviolet light source and means for moving said air over the surface of the ultraviolet light, said apparatus being arranged so that the air is made to flow over said surface in such a way as substantially to strip away ozone formed on said surface.

2. An apparatus for oxidising organic contaminants in a stream of contaminated air comprising:
a cold combustion chamber;
at least one discharge lamp for generating ultraviolet radiation; and driving means to move the air through said chamber and over the surface of the discharge lamp, wherein said driving means is arranged to cause the air to flow over said surface at a sufficient velocity substantially to strip away a layer of ozone formed thereon.

3. An apparatus as claimed in claim 1 or 2 arranged such that the Reynold's number is within or above the transition between laminer and turbulent flow.

4. An apparatus for treating air contaminated with an organic contaminant comprising at least one source of ultra-violet light over which said contaminated air is made to flow in use wherein the apparatus is arranged such that flow of said air is turbulent or in the transition to turbulence.

5. Apparatus as claimed in claim 3 or 4 wherein the Reynold's number is more than about 4000.

6. An apparatus as claimed in any preceding claim comprising means for increasing the local air flow speed over the surface of the UV sources so as to achieve the desired flow pattern or Reynold's number.

7. An apparatus as claimed in claim 7 comprising one or more flow restricting means for increasing said flow speed.

8. An apparatus for treating contaminated air by using ultraviolet light comprising at least one ultraviolet light source and means provided in conjunction with said light source for increasing the local flow speed over the light source by restricting the flow of air thereover.

9. Apparatus as claimed in any preceding claim wherein said ultraviolet light source is arranged to emit substantially UV-C radiation.

10. Apparatus as claimed in claim 9 wherein the wavelength of said radiation is approximately 185 nanometres.

11. Apparatus as claimed in any preceding claim comprising means for removing ozone from the stream of air discharged therefrom.

12. Apparatus as claimed in claim 11 wherein said ozone reduction means comprises a further ultraviolet light source operating predominantly at a wavelength for decomposing ozone.

13. An apparatus for treating air contaminated with organic contaminants comprising a first ultraviolet light source which in use emits light at at least a first wavelength for producing ozone and a second ultraviolet light source downstream of said first light source and which in use emits light at a second wavelength for decomposing ozone wherein said second light source either does not emit at said first wavelength or any such emission is substantially attenuated compared to the first light source.

14. An apparatus as claimed in claim 13 wherein said first and second wavelengths are in the UV-C band.

15. An apparatus as claimed in claim 13 or 14 wherein said first wavelength is approximately 185 nanometres.

16. An apparatus as claimed in claim 13, 14 or 15 wherein said second wavelength is approximately 254 nanometres.

17. An apparatus for oxidising organic contaminants in a stream of air comprising means for introducing ozone into the airstream and an ultraviolet light source downstream thereof for irradiating said airstream with ultraviolet light at such a wavelength that it decomposes ozone in the airstream.

18. An apparatus as claimed in claim 17 wherein said ultraviolet light source emits at approximately 254 nanometres.

19. An apparatus as claimed in claim 18 wherein said ultraviolet light source is housed in a highly reflective chamber.

20. An apparatus as claimed in any preceding claim which is arranged to give a suitable residence time for oxidation reactions in the air being treated to be substantially completed.

21. An apparatus for treating contaminated air containing organic contaminants comprising an ultraviolet light source arranged to irradiate contaminated air streaming past it and a reaction chamber for containing said air for a minimum predetermined period, said period being sufficiently long to allow oxidation reactions involving the organic contaminants in the air to be substantially completed.

22. An apparatus as claimed in claim 20 or 21 wherein the residence time is between 0.25 and 4 seconds.

23. An apparatus as claimed in claim 20, 21 or 22 comprising a duct for conveying irradiated air from the UV light source, said duct being sufficiently long to give the desired residence time.

24. Apparatus as claimed in any preceding claim arranged so that in use contaminated air entering the apparatus is brought into contact with water droplets prior to being irradiated by UV light.

25. An apparatus for removing organic contaminants from a stream of air passing therethrough comprising means for applying droplets of liquid to said air stream and an ultraviolet light source downstream of said liquid application means for irradiating said airstream.

26. An apparatus as claimed in claim 24 or 25 wherein said liquid comprises water.

27. An apparatus as claimed in claim 24, 25 or 26 comprising means for applying droplets of liquid to the air stream, said means being arrange to distribute the liquid in the form of a spray or curtain or by passing the liquid over a suitable structure on the air stream to create said droplets.

28. An apparatus as claimed in any of claims 24 to 27 wherein the liquid is recycled within the apparatus.

29. An apparatus as claimed in claim 28 comprising a plurality of circuits for recycling of the liquid, said circuits being arranged such that the coldest liquid is used to contact the air exiting the liquid treatment apparatus.

30. Apparatus as claimed in any of claims 24 to 29 comprising means to remove grease from the liquid or water which has come into contact with the contaminated air.

31. Apparatus as claimed in any of claims 24 to 30 comprising separation means for separating said liquid or water droplets from the air.

32. Apparatus as claimed in any preceding claim comprising means for reducing the humidity of the air stream.

33. An apparatus for treating contaminated air comprising an ultra-violet light source arranged to irradiate contaminated air passing through the apparatus, and means for regulating the humidity of the air passing through the apparatus prior to it being irradiated by the ultra-violet light source.

34. An apparatus as claimed in claim 32 or 33 comprising means for adding a gas having a lower density point than the main air stream.

35. A modular air decontaminating unit for a ventilation system comprising at least one ultraviolet discharge lamp for generating ozone from oxygen in the air.

36. A modular decontaminating unit as claimed in claim 35 comprising driving means for driving air over the ultraviolet discharge lamp.

37. A method of oxidising organic contaminants in a stream of contaminated air comprising moving the contaminated air through a cold combustion chamber comprising at least one discharge lamp, said discharge lamp generating ultraviolet radiation thereby forming a layer of ozone on a surface thereof, wherein the air is moved so as to flow over the surface of the lamp at a sufficiently high velocity substantially to strip said ozone layer from said surface.

38. A method of treating air contaminated with an organic contaminant comprising making said air flow over at least one source of ultra-violet light such that flow of said air is turbulent or in the transition to turbulence.

39. A method of treating contaminated air by causing it to flow over at least one ultraviolet light source comprising increasing the local flow speed over the light source by restricting the flow of air thereover.

40. A method of treating air contaminated with organic contaminants comprising irradiating said air with a first ultraviolet light source emitting light at at least a first wavelength for producing ozone and irradiating said air with a second ultraviolet light source downstream of said first light source and emitting light at a second wavelength for decomposing ozone wherein said second light source either does not emit at said first wavelength or any such emission is substantially attenuated compared to the first light source.

41. A method of oxidising an organic contaminants in a stream of air comprising introducing ozone into the airstream and irradiating said airstream with ultraviolet light at such a wavelength that it decomposes ozone in the airstream.

42. A method of treating contaminated air containing organic contaminants comprising irradiating contaminated air streaming past an ultraviolet light source and containing said air for a minimum predetermined period in a reaction chamber, said period being sufficiently long to allow oxidation reactions involving the organic contaminants in the air to be substantially completed.

43. A method of removing organic contaminants from a stream of air comprising applying droplets of liquid to said air stream and irradiating said airstream with ultraviolet light downstream of said liquid application.

44. A method of treating contaminated air comprising irradiating contaminated air with ultra-violet light and regulating the humidity of the air passing through the apparatus prior to it being irradiated by the ultra-violet light.
